(19) United States
(12) Patent Application Publication
(10) Pub. No.: US 2006/0262348 A1
(43) Pub. Date: Nov. 23, 2006

(54) Page output control apparatus and page output control program storage medium

(75) Inventors: Yasuharu Aoki, Kanagawa (JP); Tetsuya Sano, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/435,847

(22) Filed: May 18, 2006

(30) Foreign Application Priority Data
May 18, 2005 (JP) 2005-145464

(51) Int. Cl. G06F 3/12

(52) U.S. Cl. 358/1.15

(57) ABSTRACT

A page output control apparatus includes a page group acquisition section that obtains a group of pages that consists of a series of pages, an output condition setting section that specifies a first number of sets that is counted with the page group as one set and a second number of sets that is less than the first number of sets, and an output control section that causes a printer to output the first number of sets and causes the printer to insert a blank sheet at every second number of sets and to output pages equivalent to the first number of sets.

### BACKGROUND OF THE INVENTION

1. Field of the Invention

The present invention relates to a page output control apparatus for controlling page output on a page output apparatus that records a page on a sheet and outputs the same, and a page output control program storage medium having stored thereon a page output control program for causing a computer to operate as the page output control apparatus.

2. Description of the Related Art

Recent computerization in the field of printing has brought widespread use of such a technique that allows an editor to edit pages of printed material on a computer for editing and use image data representing images of the pages with layout of letters and pictures on them determined as an original. Along with such computerization, so called on-demand printing that enables prompt printing of a desired image when necessary has been also realized.

In on-demand printing, so-called collation output is possible where an output operation that outputs pages in sequence is repeated a number of times corresponding to a required number of sets when multiple sets of printed material that consists of multiple pages are prepared. In such collation output, pages are often output simply being stacked from a page output apparatus. Consequently, in order to facilitate sorting of printed material after output by making it clear where page sets separate, so-called slip sheet insertion has been proposed that inserts a sheet distinct from the printed material at every set when outputting pages (see Japanese Patent Laid-Open No. 2002-179268, for example).

Printed material is often divided into a number of groups for the purpose of packing or transportation. Although the slip sheet insertion is useful for such sorting, when a large number of sets are required for each of such groups, it would be a significant burden on a worker just to count slip sheet inserted at every set and take a required number of sets.

### SUMMARY OF THE INVENTION

The present invention provides a page output control apparatus for controlling page output on a page output apparatus so as to reduce time and effort required for sorting after output, and a page output control program storage medium that stores thereon a page output control program for causing a computer to operate as the page output control apparatus.

The present invention provides a page output control apparatus, including:

a page group acquisition section that obtains a page group that consists of a series of pages;

a number of sets specifying section that specifies a first number of sets that is counted with the page group as one set and a second number of sets that is less than the first number of sets; and

an output control section that causes a page output apparatus for outputting pages by recording the same on sheets to output the first number of sets and that causes the page output apparatus to insert a blank sheet having nothing recorded thereon at every second number of sets and to output pages equivalent to the first number of sets.

According to the page output control apparatus of the invention, pages output by the page output control apparatus are stacked with blank sheets inserted at every number of sets that is specified by the number of sets specifying section. This facilitates sorting of pages into multiple page groups by means of the blank sheets. For example, if ten sets are specified at the number of sets specifying section, when one separates a stack of pages corresponding to one-hundred page groups into sixty and forty sets, sorting can be performed very easily by dividing the stack into pages corresponding to six blank sheets and pages corresponding to four blank sheets. Also, when a stack of one hundred page groups is separated into five groups of twenty sets, for example, by specifying the number of sets to twenty at the number of sets setting section, sorting can be performed just by dividing the page stack into groups that are separated by the blank sheets. Thus, according to the page output control apparatus of the invention, page output on a page output apparatus can be controlled so as to reduce time and effort spent on sorting after output.

Also, for the page output control apparatus of the invention, it is a preferable that the output control section controls a page output apparatus that has a plurality of types of sheet, and causes the page output apparatus to use sheets of a different type from the sheets for recording pages of the page group as sheets to be inserted at every second number of sets.

According to this additional feature, sorting can be further facilitated by employing, as the sheets to be inserted at every second number of sets, sheets having a different color from page recording sheets or so-called tab sheets having a protruding portion for writing an index so that a worker can readily see separation by those sheets when sorting.

Also, for the page output control apparatus of the invention, it is also preferable that the output control section causes blank sheets to be inserted at every one set in addition to insertion of sheets at every second number of sets.

According to additional feature, it is easy not only to sort pages into page groups but to sort pages by the set, thereby further facilitating sorting.

Also, the present invention provides a page output control program storage medium that stores thereon a page output control program that is incorporated into a computer, and implements on the computer:

a page group acquisition section that obtains a page group that consists of a series of pages;

a number of sets specification section that specifies a first number of sets that is counted with the page group as one set and a second number of sets that is less than the first number of sets; and

an output control section that causes a page output apparatus for outputting pages by recording the same on sheets to output the first number of sets of the page groups and that causes the page output apparatus to insert a blank sheet having nothing recorded thereon at every second number of sets and to output pages equivalent to the first number of sets.

According to the page output control program storage medium of the invention, a page output control apparatus can be realized easily that controls page output on a page output apparatus so as to reduce time and effort spent on sorting after output.

As to the page output control program storage medium of the invention, only its basic feature is shown here. This is simply for the sake of avoiding overlap, and the page output control program storage medium of the invention includes various aspects corresponding to the aspects of the page output control apparatus.

As has been described, according to the invention, page output on a page output apparatus can be controlled so as to reduce time and effort for sorting after output.

### BRIEF DESCRIPTION OF THE DRAWINGS

FIG. 1 illustrates a printing system into which an embodiment of the invention is incorporated;

FIG. 2 shows a hardware configuration of a computer that implements an RIP apparatus;

FIG. 3 shows an embodiment of the page output control program of the invention;

FIG. 4 is a functional block diagram for the RIP apparatus;

FIG. 5 illustrates a setup screen on which output conditions on a printer of FIG. 1 are set;

FIG. 6 is a flowchart illustrating an output instruction process executed at an output control section shown in FIG. 4; and

FIG. 7 illustrates pages output from the printer of FIG. 1 being stacked when the output instruction process shown in the flowchart of FIG. 6 is executed.

### DETAILED DESCRIPTION OF THE INVENTION

In the following, an embodiment of the invention will be described with reference to drawings.

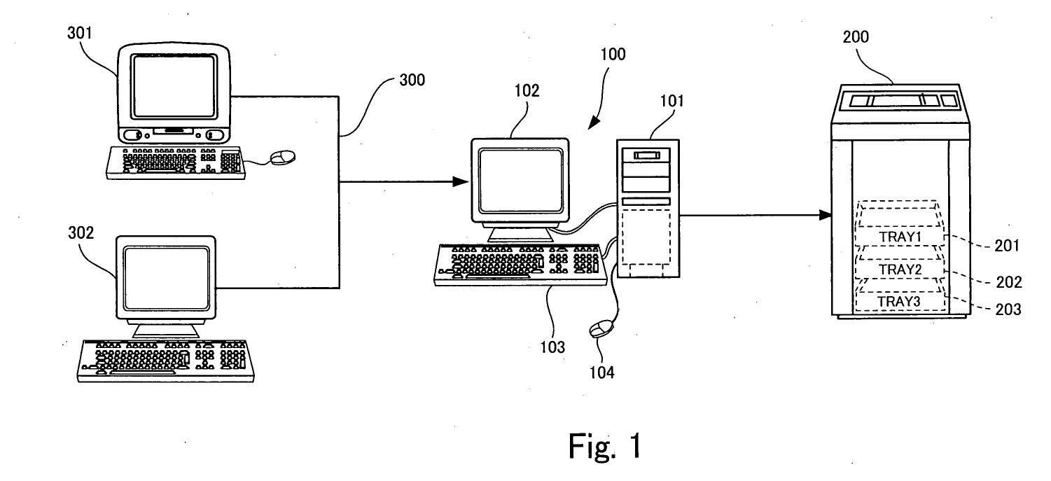

FIG. 1 illustrates a printing system into which an embodiment of the invention is incorporated.

In FIG. 1, there are shown computers implementing editing apparatuses 301 and 302, a computer implementing an RIP apparatus 100, and a printer 200.

Pages that make up a printed material are edited as data on the editing apparatuses 301 and 302, and image data representing the pages is sent to the RIP apparatus 100 via a communication network 300.

The RIP apparatus 100 receives image data from the editing apparatuses 301 and 302, converts the data into image data (raster data) for the printer 200 that represents the image as a raster image, and outputs the image data to the printer 200. In addition to being received over the communication network 300, the image data may be received on a storage medium such as a Compact Disc Recordable (CD-R) or a Magneto-Optical (MO) disc. When the RIP apparatus 100 receives image data representing each of a series of pages from the editing apparatuses 301 and 302 and converts the data into a series of raster data and outputs the raster data to the printer 200, it outputs the pages represented by each of the raster data in sequence. Further, the RIP apparatus 100 can specify collation output for outputting the series of pages represented by the raster data in order, and also can control page output on the printer 200 such that a required number of page groups that consists of a series of pages are output. Further, when multiple sets of page groups are output in such a manner, sorting after output can be facilitated by controlling page output at the printer 200 so as to insert a sheet on which nothing is recorded at every required number of sets or insert such a sheet at every set. Hereinafter, insertion of a sheet having nothing recorded thereon at every required number of sets will be referred to as slip sheet insertion, and a sheet inserted in the slip sheet insertion will be referred to as a slip sheet. Also, insertion of a sheet having nothing recorded thereon at every set will be referred to as sheet insertion, and a sheet inserted in the sheet insertion will be referred to as a blank sheet. Details on the slip sheet insertion and sheet insertion will be described later with respect to other figures. The RIP apparatus 100 represents an embodiment of the page output control apparatus of the invention.

Upon receipt of image data from the RIP apparatus 100, the printer 200 outputs an image represented by the image data onto a sheet with toner of four colors, i.e., cyan (C), magenta (M), yellow (Y), and black (K), by way of electrophotography. The printer 200 further has three trays 201, 202, and 203 which contain different types of sheet. A tray for feeding sheets on which images are to be output is specified at the RIP apparatus 100. A tray for feeding sheets to be used as slip sheets or blank sheets in the slip sheet insertion or sheet insertion respectively is also specified at the RIP apparatus 100.

In the printing system shown in FIG. 1, a feature as an embodiment of the invention lies in the operation performed in a computer that operates as the RIP apparatus 100. Thus, in the following, description will be given focusing on the RIP apparatus 100.

The RIP apparatus 100 of FIG. 1 is implemented by a computer as mentioned above, and the computer includes a main unit 101 containing a CPU, a main memory, a hard disk, a communication board and so on, a CRT display 102 for displaying images and character strings on a display screen in accordance with instructions from the main unit 101, a keyboard 103 for inputting a user's command and character information to the computer, and a mouse 104 for specifying a position on the display screen of the CRT display 102 so as to input a command corresponding to an icon and the like displayed at the position.

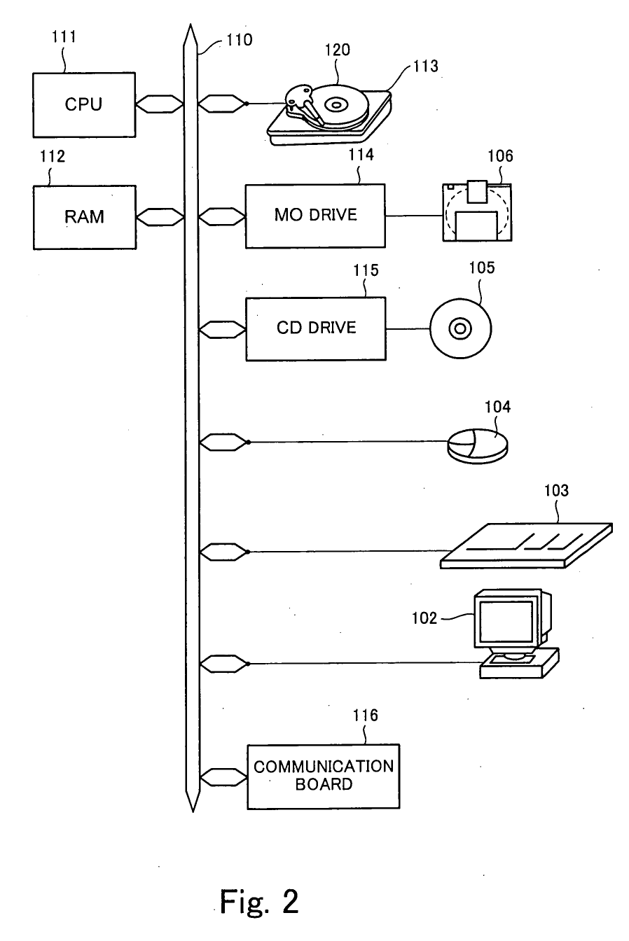

A CD-ROM 105 (not shown in FIG. 1. See FIG. 2) or a CD-R is removably mounted to the main unit 101 and the main unit 101 includes a CD drive for reproducing information stored in the mounted CD-ROM 105 or a CD-R. A magneto-optical disk (MO) 106 (not shown in FIG. 1. See FIG. 2) is also removably mounted to the main unit 101, and the main unit 101 also includes an MO drive for recording/reproducing information to and from the mounted MO 106.

FIG. 2 shows a hardware configuration of a computer that implements the RIP apparatus.

The hardware configuration illustrates a central processing unit (CPU) 111, a RAM 112, a hard disk drive (HDD) 113, an MO drive 114, a CD drive 115, and a communication board 116, which are interconnected by a bus 110.

The HDD 113 contains a hard disk 120, a kind of storage media, and records/reproduces information to and from the hard disk 120.

The communication board 116 is connected to a communication line such as a local area network (LAN). The RIP apparatus 100 shown in FIG. 1 is capable of communicating data with another computer system as well as outputting image data to the printer 200 over the communication network 300 to which the RIP apparatus 100 is connected via the communication board 116.

FIG. 2 also shows the mouse 104, keyboard 103, and CRT display 102, which are also shown in FIG. 1, connected to the bus 110 via respective I/O interfaces not shown.

Here, the CD-ROM 105 is an embodiment of the page output control program storage medium of the invention and stores thereon a page output control program of the invention. The CD-ROM 105 is mounted into the main unit 101 and the page output control program stored in the CD-ROM 105 is read out by the CD drive 115 to be installed in the hard disk 120 via the bus 110.

When the page output control program installed in the hard disk 120 is launched, the page output control program in the hard disk 120 is loaded to the RAM 112 and executed by the CPU 111. When the page output control program of the invention is launched and executed, the RIP apparatus 100 operates as an embodiment of the page output control apparatus of the invention.

While FIG. 2 illustrates the CD-ROM 105 as an embodiment of the page output control program storage medium, the page output control program storage medium of the invention is not limited to a CD-ROM: it may be other storage media such as an optical disk, an MO disk, a flexible disk (FD), and a magnetic tape. Further, the page output control program of the invention may be directly supplied to a computer over a communication network.

In the following description, elements shown in FIGS. 1 and 2 will be referred to without specifically noting figure numbers.

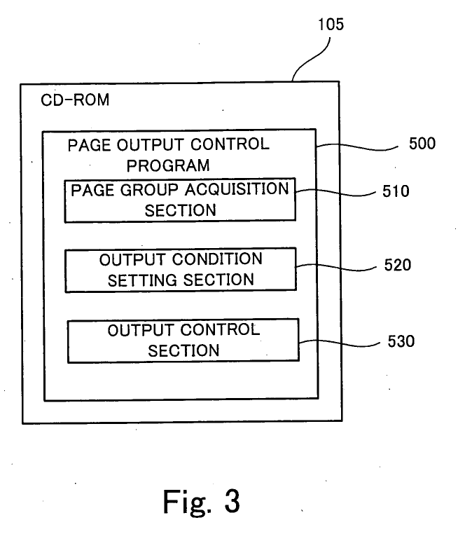

FIG. 3 shows an embodiment of the page output control program storage medium of the invention.

FIG. 3 illustrates the CD-ROM 105 as an embodiment of the page output control program storage medium of the invention in which the page output control program 500 is stored.

The page output control program 500 is executed in the computer serving as the RIP apparatus 100 shown in FIG. 1 to cause the RIP apparatus 100 to operate as an embodiment of the page output control apparatus of the invention, and includes a page group acquisition section 510, an output condition setting section 520, and an output control section 530. Details on each of the sections of the page output control program 500 will be described below.

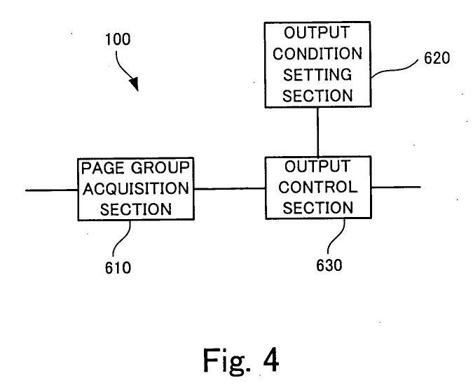

FIG. 4 is a functional block diagram of the RIP apparatus 100 shown in FIG. 1.

The RIP apparatus 100 is implemented by the page output control program 500 of FIG. 3 being installed in a computer and executed.

The RIP apparatus 100 has a page group acquisition section 610, an output condition setting section 620, and an output control section 630.

The page group acquisition section 610, output condition setting section 620, and output control section 630 are implemented on a computer by the page group acquisition section 510, the output condition setting section 520, and the output control section 530, which constitute the page output control program 500 shown in FIG. 3, being incorporated into the computer. Thus, the elements of FIG. 4 each correspond to the elements of FIG. 3, however, the difference is that the elements of FIG. 4 are implemented by the combination of hardware of a computer and an OS or application program executed in the computer, whereas the elements of the page output control program 500 shown in FIG. 3 are implemented only by the application program. The page group acquisition section 610, output condition setting section 620, and output control section 630 correspond to an example of the page group acquisition section, the number of sets specifying section and the output control section of the page output control apparatus of the invention, respectively.

The page group acquisition section 610 obtains a series of image data representing each of a series of pages that constitute a page group equivalent to one set. The obtained image data is converted into raster data and passed to the output control section 630.

At the output condition setting section 620, for the page group, various output conditions including a desired number of copies to be output on the printer 200 for a printed material, and settings for collation output, slip sheet insertion, and sheet insertion are designated through an input operation by an operator on a setup screen, which will be discussed below.

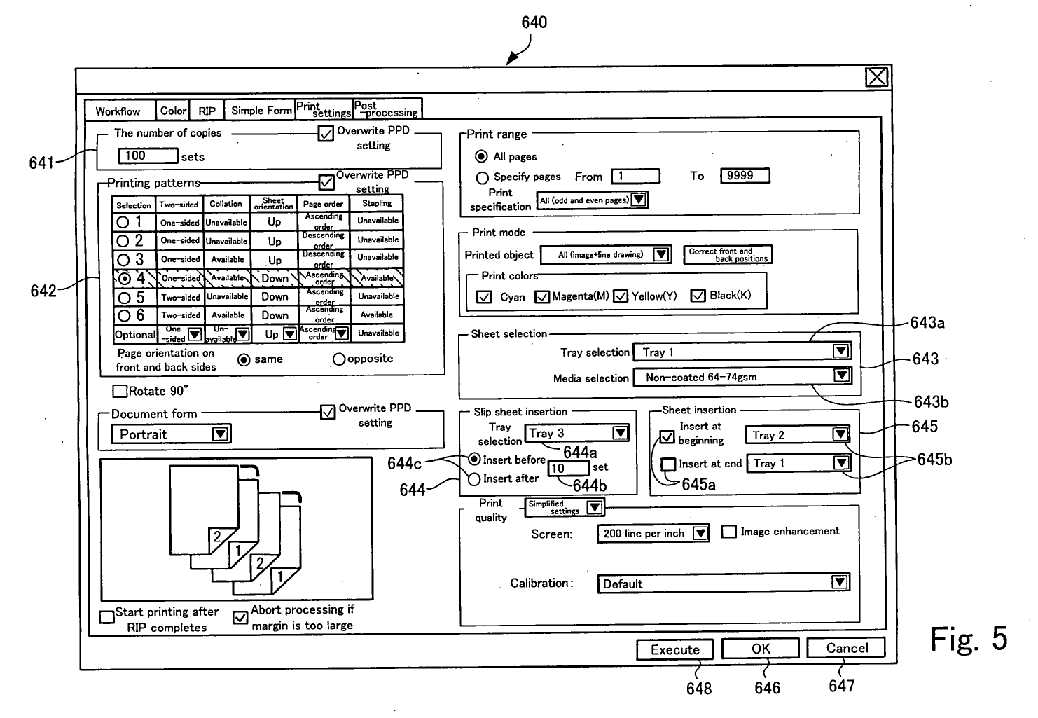

FIG. 5 illustrates a setup screen for setting output conditions for the printer 200 in FIG. 1.

In the following, a setup screen 640 of FIG. 5 will be described with particular reference to areas in which settings relating to the desired number of copies, collation output, slip sheet insertion, and sheet insertion are made. Although the setup screen 640 includes other areas for various settings such as printing range or color materials for use in printing, description on them is omitted since they are not essential to the invention.

The setup screen 640 includes a number-of-copies setting section 641, a printing pattern setting section 642, a sheet selection section 643, a slip sheet insertion setting section 644, a sheet insertion setting section 645, an OK button 646, a Cancel button 647, and an Execute button 648.

In the number-of-copies setting section 641, a desired number of copies to be output for a printed material is input by value.

In the printing pattern setting section 642, five conditions are established, i.e., whether an image is output on the both sides or one side of a sheet, whether collation output is performed, the orientation of an image relative to the sheet, whether a series of pages are output in ascending or descending order, and whether stapling of a page group is performed. In this embodiment, it is possible to select any desired one of six combinations of these five conditions, and also to set each of the conditions freely.

In the sheet selection section 643, a type of sheet on which images for individual pages are output is specified. Sheet selection may be made by operating a pull-down menu 643a for tray selection and choosing a desired tray from the three trays 201, 202, and 203 provided in the printer 200, or by operating a pull-down menu 643b for media selection and directly specifying a sheet type.

In the slip sheet insertion setting section 644, a tray for feeding sheets to be used as slip sheets is first selected from the three trays 201, 202, and 203 of the printer 200 by operating a pull-down menu 644a for tray selection. Further, the number of sets at which a slip sheet is inserted is input as a value to the number of sets input section 644a, and whether a slip sheet is inserted before or after pages of the input number of sets is specified by clicking on one of radio buttons 644c.

In the sheet insertion setting section 645, if a blank sheet for insertion is inserted at every set, it is first specified by checking check boxes 645a whether or not a blank sheet is inserted at the beginning of a set as well as whether or not a blank sheet is inserted at the end of a set. Next, for each of blank sheets to be inserted at the beginning and end of a set, a tray for feeding the sheets is selected from the three trays 201, 202, and 203 of the printer 200 by operating the pull-down menu 645b for tray selection.

After various setting operations including the operations described above are complete, the OK button 646 is clicked if one accepts the settings, or the cancel button 647 is clicked if one wants to clear and making settings again. Then, when the Execute button 648 is clicked after the OK button 646 is clicked, conditions that are set on the setup screen 640 are passed to the output control section 630 of FIG. 4 and image output based on those conditions is initiated.

The output control section 630 repeatedly sends raster data passed from the page group acquisition section 610 to the printer 200 in sequence a number of times equal to the number of copies that has been input in the number of copies setting section 641. During the process, the output control section 630 instructs the printer 200 to use sheets in the tray specified at the sheet insertion setting section 645 as blank sheets for insertion and insert them at specified insertion positions, and further to insert sheets in the specified tray as slip sheets at specified insertion positions at every number of sets that have been specified in the slip sheet insertion setting section 644.

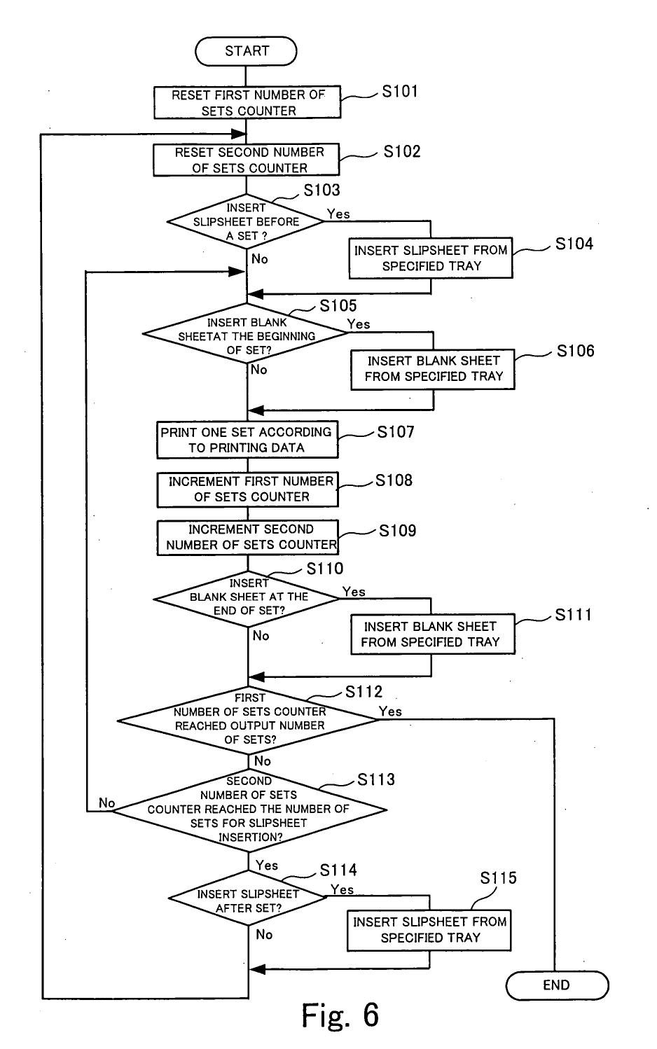

FIG. 6 is a flowchart illustrating the output instruction process that is executed at the output control section of FIG. 4. In the following description, elements shown in FIG. 1 and FIG. 5 will be referred to without specifically noting figure numbers.

The output instruction process illustrated by the flowchart of FIG. 6 starts when the Execute button 648 is clicked on the setup screen 640 shown in FIG. 5.

After the process is started, a first number of sets counter is initially reset (step S101), then a second number of sets counter is reset (step S102).

Then, it is determined whether or not the position for slip sheet insertion that has been set in the slip sheet insertion setting section 644 is before a slip sheet insertion set that consists of pages corresponding to the number of sets that has been input in the slip sheet insertion setting section 644 (step S103). If the slip sheet insertion position is before the slip sheet insertion set (Yes at step S103), the printer 200 is instructed to output sheets in a tray that is specified as the slip sheet tray in the slip sheet insertion setting section 644 (step S104), and the procedure proceeds to the next process (step S105). Meanwhile, if the slip sheet insertion position is after the slip sheet insertion set (No at step S103), the procedure proceeds to step S105 without going through step S104.

At step S105, it is determined whether or not insertion of a blank sheet at the beginning of a page group equivalent to one set has been set at the sheet insertion setting section 645. If insertion of a blank sheet at the beginning of a set is specified (Yes at step S105), the printer 200 is instructed to output sheets of a tray that is specified as the blank sheet tray in the sheet insertion setting section 645 (step S106), and the procedure proceeds to the next process (step S107). On the other hand, if insertion of a blank sheet at the beginning of a set has not been specified (No at step S105), the procedure proceeds to step S107 without going through step S106.

At step S107, raster data representing each of a series of pages is sequentially sent to the printer 200. At this point, if output of the pages in ascending order is specified at the printing pattern setting section 642, the raster data is sent in ascending order, and if output in descending order is specified, the raster data is sent in descending order.

After raster data corresponding to the series of pages is sent at step S107, the first number of sets counter is incremented by one (step S108), and then the second number of sets counter is also incremented by one (step S109).

Next, it is determined whether or not insertion of a blank sheet at the end of the page group as one set has been specified at the sheet insertion setting section 645. If insertion of a sheet at the end of a set is specified (Yes at step S110), the printer 200 is instructed to output sheets in the tray that is specified at the sheet insertion setting section 645 (step S111), and the procedure proceeds to the next process (step S112). Meanwhile, if insertion of a blank sheet at the end of a set is not specified (No at step S110), the procedure proceeds to step S112 without going through step S111.

At step S112, it is determined whether or not the first number of sets counter has reached a desired number of copies that has been set in the-number-of-copies setting section 641. If it is determined at step S112 that the first number of sets counter has not reached the desired number of copies yet (No at step S112), it is determined whether or not the second number of sets counter has reached the number of sets at which a slip sheet is inserted that has been specified in the slip sheet insertion setting section 644 (step S113).

When it is determined at step S113 that the second number of sets counter has not reached the number of sets for slip sheet insertion yet (No at step S113), the procedure returns to step S105.

If it is determined at step S113 that the second number of sets counter has reached the number of sets for slip sheet insertion (Yes at step S113), then it is determined whether or not the position for slip sheet insertion specified at the slip sheet insertion setting section 644 is after a slip sheet insertion set that consists of pages equivalent to the number of sets that was input at the slip sheet insertion setting section 644 (step S114). If the slip sheet insertion position is after the slip sheet insertion set (Yes at step S114), the printer 200 is instructed to output sheets in the tray that has been specified as the slip sheet tray at the slip sheet insertion setting section 644 (step S115), and the procedure returns to step S102 to repeat processes from step S102 to step S115. These processes are continued until it is determined at step S112 that the first number of sets counter has reached the desired number of sets that was set at the number-of-copies setting section 641 (Yes at step S112). When it is determined that the first number of sets counter has reached the desired number of sets (Yes at step S112), the output instruction process is terminated.

When the output instruction process illustrated by the flowchart described above is executed at the output control section 630, pages are output on the printer 200 as follows.

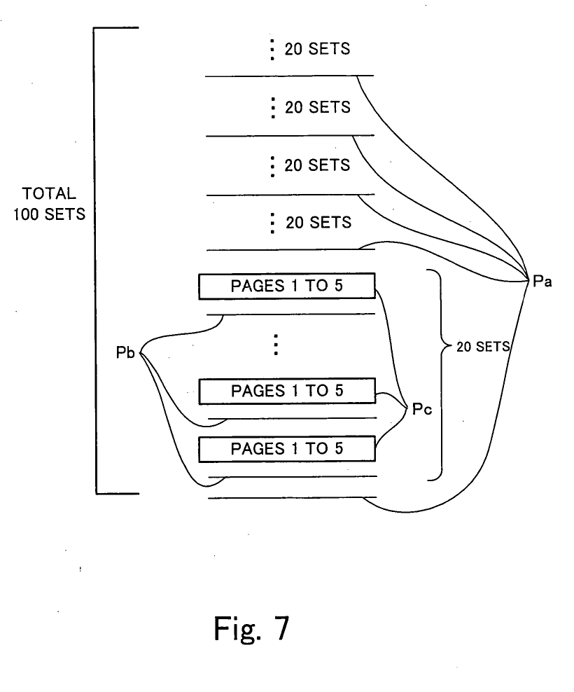

FIG. 7 is a schematic view illustrating pages output by the printer 200 of FIG. 1 being stacked when the output instruction process of the flowchart in FIG. 6 is executed.

FIG. 7 illustrates page groups that are output by the printer 200 in the case the desired number of copies to be output for a printed material is set to one hundred at the number-of-copies setting section 641 of FIG. 5, insertion of a slip sheet at the beginning of every twenty sets of page groups is specified at the slip sheet insertion setting section 644, and insertion of a blank sheet at the beginning of every page group is specified at the sheet insertion setting section 645.

When pages are output according to those settings, one slip sheet Pa is first output, then one blank sheet Pb is output, and then a page group Pc as one set is output. After output of blank sheet Pb and output of the page group Pc as one set are repeated twenty times, one slip sheet Pa is output again. Then, when the number of output page groups Pc has reached one hundred, the output stops. The pages stacked in such a manner have slip sheets Pa inserted therein at every twenty sets, so that it is easy to divide the hundred sets of page groups Pc into twenty-set groups or to divide the hundred sets of page groups Pc into forty and sixty sets, for example. Also, insertion of the blank sheet Pb at every set allows one to take a page group corresponding to one set easily.

Also, in this embodiment, a tray for feeding sheets to be used as slip sheets Pa is specified from the three trays 201, 202, and 203 of the printer 200 at the slip sheet insertion setting section 644, and a tray for feeding sheets used as the blank sheet Pb is specified from the three trays 201, 202, and 203 at the sheet insertion setting section 645. Here, by setting sheets for page recording, sheets having a color different from the blank sheet, or so-called tab sheets that have a protruding portion for writing an index, in a tray specified for feeding slip sheets Pa, it is possible to further facilitate sorting by way of slip sheets Pa.

As has been thus described, according to the RIP apparatus 100 of the invention, page output on the printer 200 can be controlled so that time and effort required for sorting after output is reduced.

Although the RIP apparatus 100 that causes a printer to execute both slip sheet insertion and sheet insertion has been shown as an embodiment of the page output control apparatus of the invention, the present invention is not limited thereto: the page output control apparatus of the invention may cause a printer to execute only slip sheet insertion.

Also, although the above description employs, as an example of the number of sets setting section of the invention, the output condition setting section 620 that specifies a tray of the printer for feeding sheets or a type of sheet to be used for recording sheets, and specifies only a tray of the printer for feeding sheets to be used as slip sheets or blank sheets for insertion, the present invention is not limited thereto. Rather, the number of sets setting section of the invention may also allow specification of a sheet type to be used as slip sheets and blank sheets for insertion. Also, the number of sets setting section of the invention may provide fixed types of sheet or fixed trays containing such sheets for each of recording sheets, slip sheets, and blank sheets for insertion.

What is claimed is:

1. A page output control apparatus, comprising:
a page group acquisition section that obtains a page group that consists of a series of pages;
a number of sets specifying section that specifies a first number of sets that is counted with the page group as one set and a second number of sets that is less than the first number of sets; and
an output control section that causes a page output apparatus for outputting pages by recording the same on sheets to output the first number of sets and that causes the page output apparatus to insert a blank sheet having nothing recorded thereon at every second number of sets and to output pages equivalent to the first number of sets.

2. The page output control apparatus according to claim 1, wherein the output control section controls a page output apparatus that has a plurality of types of sheet, and causes the page output apparatus to use sheets of a different type from the sheets for recording pages of the page group as sheets to be inserted at every second number of sets.

3. The page output control apparatus according to claim 1, wherein the output control section causes blank sheets to be inserted at every one set in addition to insertion of sheets at every second number of sets.

4. A page output control program storage medium having stored thereon a page output control program that is incorporated into a computer, and implementing on the computer:
a page group acquisition section that obtains a page group that consists of a series of pages;
a number of sets specification section that specifies a first number of sets that is counted with the page group as one set and a second number of sets that is less than the first number of sets; and
an output control section that causes a page output apparatus for outputting pages by recording the same on sheets to output the first number of sets and that causes the page output apparatus to insert a blank sheet having nothing recorded thereon at every second number of sets and to output pages equivalent to the first number of sets.
